(19) United States
(12) Patent Application Publication
(10) Pub. No.: US 2006/0112937 A1
(43) Pub. Date: Jun. 1, 2006

(54) Fuel supply system

(76) Inventor: Michael Tittmann, Hanau (DE)

Correspondence Address: MAYER, BROWN, ROWE & MAW LLP, P.O. BOX 2828, CHICAGO, IL, 60690-2828, US

(21) Appl. No.: 10/517,883

(22) PCT Filed: May 26, 2004
(86) PCT No.: PCT/EP04/50924

§ 371 Date: Dec. 29, 2005

(30) Foreign Application Priority Data
Jun. 16, 2003 (DE) 10327320.4

(51) Int. Cl. F02M 37/00

(52) U.S. Cl. 123/510

(57) ABSTRACT

In a fuel supply system having a plurality of surge chambers (6, 6′), a suction jet pump (14, 14′) is arranged at a designated height in each surge chamber (6, 6′). The suction jet pumps (14, 14′) in each case feed fuel from one surge chamber (6, 6′) into another surge chamber (6, 6′). By this means, when the fuel tank (1) is virtually empty, the fuel is distributed via the surge chambers (6, 6′). This prevents one of the surge chambers (6, 6′) from draining.

### BACKGROUND OF THE INVENTION

The invention relates to a fuel supply system for feeding fuel from a fuel tank to an internal combustion engine of a motor vehicle with a plurality of feed units arranged in the fuel tank, in which the feed units each have a surge chamber for collecting fuel and at least one suction jet pump for filling one of the surge chambers.

Fuel supply systems of this type are used, for example, for motor vehicles having a high power consumption and narrow fuel tanks, in which an individual, heavy-duty feed unit frequently cannot be fitted, and are known from practice. The filling of the surge chambers takes place by means of the fuel pumps arranged in the surge chambers and/or by means of the division of fuel returned into the fuel tank by the internal combustion engine and via the suction jet pumps which collect fuel from the fuel tank in the surge chambers. The suction jet pumps are generally supplied with fuel as working fluid by the feed units.

The disadvantage of the known fuel supply systems is that a continuous filling of all of the surge chambers with fuel cannot be ensured reliably in all applications. For example, motor vehicles today frequently do not have a return line or, in certain load states of the internal combustion engine, less fuel is returned via the return line. The filling of the surge chamber via the suction jet pump, which sucks up from the fuel tank, or via the first pump stage may lead, for example, when cornering, to the suction jet pump or the suction point dipping out of the fuel and to filling of the particular surge chamber not taking place. There is therefore the risk of one of the surge chambers draining although there is sufficient fuel in the fuel tank. However, if one of the surge chambers drains, there is the risk that a fuel pump of the feed unit arranged in this surge chamber will run dry and therefore be damaged.

The invention is based on the problem of designing a fuel supply system of the type mentioned at the beginning in such a manner that the fuel is reliably distributed over the surge chambers.

### BRIEF DESCRIPTION OF THE INVENTION

This problem is solved according to the invention by a suction side of the suction jet pump provided for filling a first surge chamber being arranged in a second surge chamber.

This design enables fuel to be sucked out of a sufficiently filled surge chamber by means of the suction jet pump and to be supplied to the other insufficiently filled surge chamber. The fuel collected in one of the surge chambers is therefore distributed over the remaining surge chambers. It is therefore not required for the fuel returned by the return line to be distributed. The fuel supply system according to the invention is therefore also suitable for motor vehicles having internal combustion engines without a return flow.

According to one advantageous development of the invention, the distribution of the fuel is further evened out if a suction jet pump is arranged in each of the surge chambers and feeds fuel into another surge chamber. By this means, two suction jet pumps feed in relation to each other and therefore produce an approximately identical fuel filling level in the surge chambers.

According to another advantageous development of the invention, an overfilling of one of the surge chambers can be avoided in a simple manner if the suction jet pumps in each case have essentially the same feed capacity.

An error in the shape or installation of the feed line of the suction jet pump may constrict the feed capacity of this suction jet pump. According to another advantageous development of the invention, a draining of one of the surge chambers due to an uneven feed capacity of a plurality of suction jet pumps can be avoided in a simple manner if the suction sides of the suction jet pumps are arranged above a designated minimum height in the surge chamber. The particular surge chamber cannot therefore be emptied below the designated minimum height by the suction jet pumps.

The fuel supply system according to the invention turns out to be particularly simple in terms of structure if each of the suction jet pumps feeding into the first suction chamber has an individual feed line leading into the first surge chamber.

The installation of the fuel supply system according to the invention in the fuel tank turns out to be particularly simple if suction jet pumps arranged in different surge chambers have a common collecting line. This design enables the number of lines which have to be laid to be kept particularly low.

According to another advantageous development of the invention, the distribution of the fuel is further evened out if the collecting line for each of the surge chambers in each case has an inflow connected to the suction jet pump and an outflow connected to the surge chamber. The collecting line may, of course, also be a collecting tank. The inflow and outflow may also take place through a respective common line.

According to another advantageous development of the invention, in motor vehicles having a return flow the operation of the suction jet pumps requires a particularly low outlay if working fluid connections of the suction jet pumps are connected to a return line returning fuel from an internal combustion engine into the fuel tank.

According to another advantageous development of the invention, an interruption in the feed of the suction jet pumps should the flow of fuel returned by the internal combustion engine fail can be avoided in a simple manner if the working fluid connections of the suction jet pumps are connected to the feed unit arranged in the same surge chamber. The suction jet pumps are preferably supplied with fuel as working fluid via a main stage of the particular feed unit while the preliminary stage is provided for the direct filling of the surge chamber.

### BRIEF DESCRIPTION OF THE DRAWINGS

The invention permits numerous embodiments. To further clarify its basic principle one of these is illustrated in the drawing and is described below. In the drawing:

FIG. 1 shows schematically a fuel supply system according to the invention with two feed units,

FIG. 2 shows schematically a further embodiment of the fuel supply system according to the invention with a collecting line,

FIG. 3 shows schematically a further embodiment of the fuel supply system according to the invention.

### DETAILED DESCRIPTION OF THE INVENTION

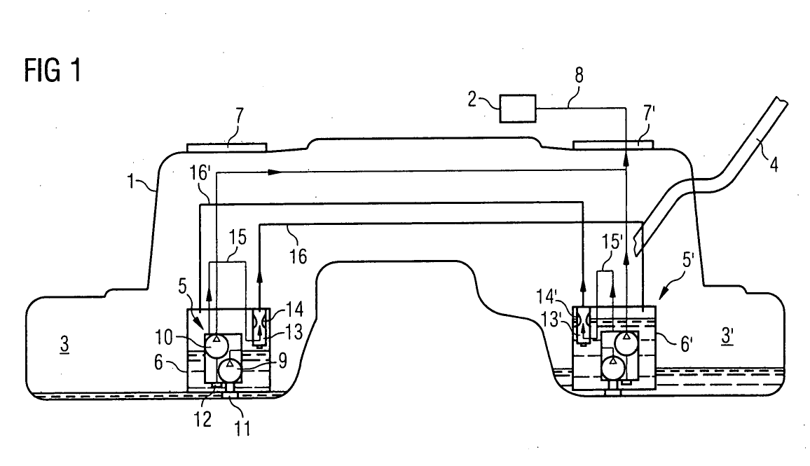

FIG. 1 shows a fuel tank 1 for a motor vehicle having a fuel supply system for supplying an internal combustion engine 2 with fuel. The fuel tank 1 is designed as a saddle tank with two chambers 3, 3′ and has a filler neck 4. The fuel supply system has two feed units 5, 5′ having a respective surge chamber 6, 6′. Directly above the feed units 5, 5′, the fuel tank 1 has mounting flanges 7, 7′. A forward-flow line 8, which is routed from the feed units 5, 5′ to the internal combustion engine 2, is guided through one of the mounting flanges 7, 7′. The system here concerns a fuel supply system “without a return flow”, in which fuel which is not used by the internal combustion engine 2 is not returned into the fuel tank 1.

The feed units 5, 5′ are electrically driven in each case and each have a preliminary stage 9 and a main stage 10. The preliminary stage 9 feeds fuel from the fuel tank 1 into the surge chamber 6 while the main stage 10 feeds fuel from the surge chamber 6 via the forward-flow line 8 to the internal combustion engine 2. The preliminary stage 9 has a filter 11 arranged in the fuel tank 1. A filter 12 of the main stage 10 is arranged in the surge chamber 6.

FIG. 1 furthermore shows that a suction side 13, 13′ of a suction jet pump 14, 14′ is in each case arranged at a designated height of the surge chambers 6, 6′. The suction jet pumps 14, 14′ in each case have working fluid connections 15, 15′, which are connected to the main stage 10 arranged in the same surge chamber 6, 6′, and feed lines 16, 16′ leading into the other surge chamber 6, 6′ in each case. The suction jet pumps 14, 14′ are supplied with fuel as working fluid via the working fluid connections 15, 15′. This enables the suction jet pumps 14, 14′ to suck up fuel from the particular surge chamber 6, 6′ and to feed the fuel into the other surge chamber 6, 6′. If the fuel filling level in one of the surge chambers 6, 6′ drops below the height of the suction side 13, 13′ of the suction jet pumps 14, 14′, the feeding of fuel out of this surge chamber 6, 6′ ceases. In this case, the surge chamber 6, 6′ is filled with fuel via the suction jet pump 14, 14′ of the other surge chamber 6, 6′.

Of course, the fuel supply system may also have more than the two surge chambers 6, 6′ illustrated. In this case, the feed lines 16, 16′ of the suction jet pumps 14, 14′ should preferably be laid in a row, so that each of the suction jet pumps 14, 14′ fills the next surge chamber 6, 6′.

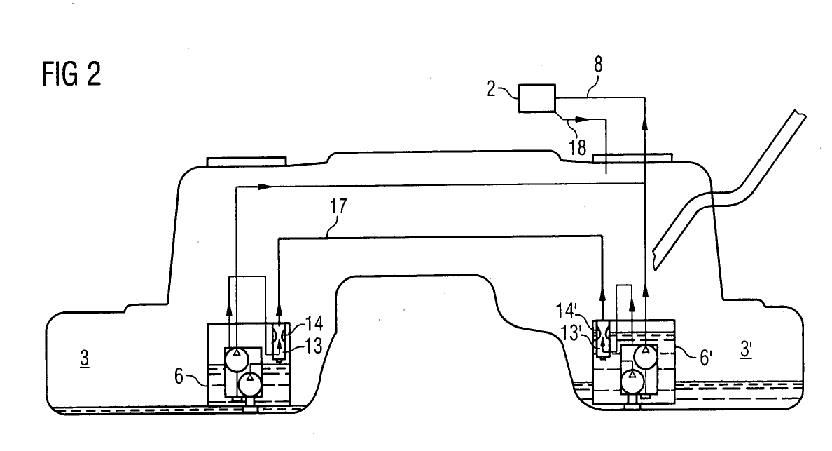

FIG. 2 shows a further embodiment of the fuel supply system, which differs from the one from FIG. 1 by the fact that the suction jet pumps 14, 14′ of the two surge chambers 6, 6′ are connected to each other via a collecting line 17. The suction jet pumps 14, 14′ therefore feed the fuel into the common collecting line 17 and build up a pressure there. If, in one of the surge chambers 6, 6′, the fuel filling level drops below the height of the-suction side 13, 13′ of the suction jet pump 14, 14′ arranged in it, the feed capacity of this suction jet pump 14, 14′ is abruptly reduced, so that fuel flows over the collecting line from the suction jet pump 14, 14′ of the other surge chamber 6, 6′. FIG. 2 furthermore shows that a return line 18 is routed from the internal combustion engine 2 into the fuel tank 1. The return line 18 leads here directly into the fuel tank 1 and may be omitted in the case of systems without a return flow.

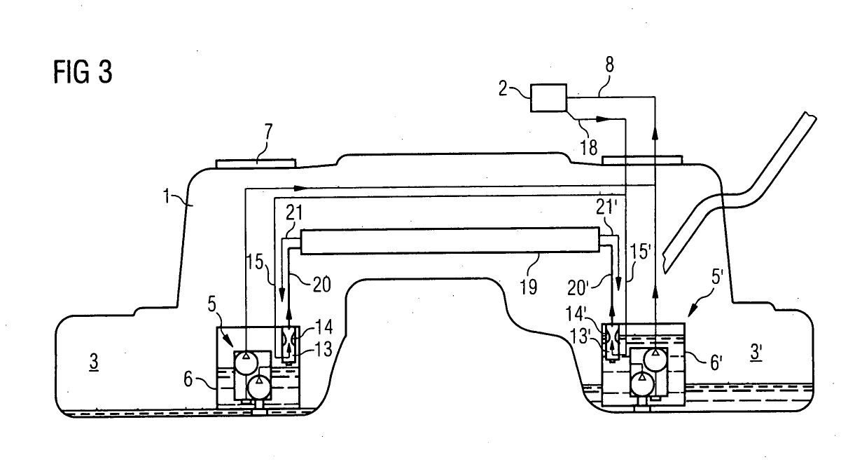

FIG. 3 shows a further embodiment of the fuel supply system, which differs from the one from FIG. 2 especially by the fact that the working fluid connections 15, 15′ of the suction jet pumps 14, 14′ arranged in the surge chambers 6, 6′ are connected to the return line 18. Both suction jet pumps 14, 14′ feed the fuel into a common collecting line 19. To distribute the fuel which has been fed, the collecting line 19 in each case has an inflow 20, 20′, which is connected to the suction jet pumps 14, 14′, and in each case has an outflow 21, 21′ leading into the surge chambers 6, 6′. Of course, this fuel supply system may also be supplied with fuel as the working fluid via the feed units 5, 5′ instead of via the return line 18. If, in one of the surge chambers 6, 6′, the fuel filling level drops below the height of the suction side 13, 13′ of the suction jet pump 14, 14′, fuel is no longer fed out of this surge chamber 6, 6′. Since fuel which has been fed overall via the outflows 21, 21′ of the collecting line 19 is distributed essentially uniformly over all of the surge chambers 6, 6′, the filling levels of the surge chambers 6, 6′ are equalized.

1. A fuel supply system for feeding fuel from a fuel tank to an internal combustion engine of a motor vehicle with a plurality of feed units arranged in the fuel tank, in which the feed units each have a surge chamber for collecting fuel and at least one suction jet pump for filling one of the surge chambers, characterized in that a suction side (13, 13′) of the suction jet pump (14, 14′) provided for filling a first surge chamber (6, 6′) is arranged in a second surge chamber (6, 6′).

2. The fuel supply system as claimed in claim 1, characterized in that a suction jet pump (14, 14′) is arranged in each of the surge chambers (6, 6′) and feeds fuel into another surge chamber (6, 6′).

3. The fuel supply system as claimed in claim 1 or 2, characterized in that the suction jet pumps (14, 14′) in each case have essentially the same feed capacity.

4. The fuel supply system as defined in claim 1, wherein the suction sides (13, 13′) of the suction jet pumps (14, 14′) are arranged above a designated minimum height in the surge chamber (6, 6′).

5. The fuel supply system as defined in claim 1, wherein each of the suction jet pumps (14, 14′) feeding into the first surge chamber (6, 6′) has an individual feed line.

6. The fuel supply system as defined in claim 1, wherein suction jet pumps (14, 14′) are arranged in different surge chambers (6, 6′) and are interconnected with a common collecting line (17, 19).

7. The fuel supply system as defined in claim 6, wherein the collecting line (19) for each of the surge chambers (6, 6′) in each case has an inflow (20, 20′) connected to the suction jet pump (14, 14′) and an outflow (21, 21′) connected to the surge chamber (6, 6′).

8. The fuel supply system as defined in claim 1, wherein working fluid connections (15, 15′) of the suction jet pumps (14, 14′) are present to connect to a return line (18) returning fuel from an internal combustion engine into the fuel tank.

9. The fuel supply system as defined in claim 8, wherein the working fluid connections (15, 15′) of the suction jet pumps (14, 14′) are connected to a feed unit (5, 5′) arranged in a surge chamber (6, 6′).
